(19) United States
(12) Patent Application Publication
(10) Pub. No.: US 2026/0120254 A1
(43) Pub. Date: Apr. 30, 2026

(54) NUCLEAR MEDICINE IMAGE GENERATION METHOD AND APPARATUS

(71) Applicant: Shanghai United Imaging Healthcare Co., Ltd., Shanghai (CN)

(72) Inventors: Yizhang Zhao, Shanghai (CN); Yihuan Lu, Shanghai (CN)

(21) Appl. No.: 19/375,333

(22) Filed: Oct. 31, 2025

(30) Foreign Application Priority Data
Oct. 31, 2024 (CN) 202411543287.2
Oct. 31, 2024 (CN) 202411543297.6

(51) Int. Cl. G06T 5/70; G06T 7/00; G06T 7/246

(52) U.S. Cl. CPC G06T 5/70; G06T 7/0014; G06T 7/248; G06T 2207/10104; G06T 2207/10108; G06T 2207/20201; G06T 2207/30004

(57) ABSTRACT

The nuclear medicine image generation method includes: acquiring motion information and scanned raw data of a scanned object at each of time points during a scan; determining three-dimensional coordinates of the scanned object at each of the time points based on the motion information at each of the time points; performing the data collation processing on the motion information at each of the time points based on the three-dimensional coordinates at each of the time points, to obtain processed motion information; and obtaining a nuclear medicine image of the scanned object based on the processed motion information and the scanned raw data.

This application claims the priority to Chinese Patent Application No. 2024115432872, entitled "NUCLEAR MEDICINE IMAGE GENERATION METHOD AND APPARATUS, COMPUTER DEVICE, READABLE STORAGE MEDIUM, AND PROGRAM PRODUCT" and filed on October 31, 2024, and the priority to Chinese Patent Application No. 2024115432976, entitled "NUCLEAR MEDICINE IMAGE GENERATION METHOD AND APPARATUS, COMPUTER DEVICE, STORAGE MEDIUM, AND PROGRAM PRODUCT" and filed on October 31, 2024. The entire contents of the above applications are incorporated herein by reference.

### TECHNICAL FIELD

The present disclosure relates to the field of image processing technologies, and in particular, to a nuclear medicine image generation method and apparatus, a computer device, and a computer-readable storage medium.

### BACKGROUND

Emission computed tomography (ECT) includes positron emission computed tomography (PET) and single photon emission computed tomography (SPECT). When a nuclear medicine image is acquired with the above method, motion of a scanned object may affect normal clinical diagnosis. Therefore, there is a need to perform motion correction on the nuclear medicine image.

In a conventional workflow, a motion signal may be acquired through an external device or from acquired raw data of a nuclear medicine scan. However, an effect of a reconstructed image is unstable affected by a motion signal sampling rate and a motion information acquisition manner.

### SUMMARY

The present disclosure provides a nuclear medicine image generation method and apparatus, a computer device, and a computer-readable storage medium.

The present disclosure provides a nuclear medicine image generation method, the method including:

acquiring motion information and scanned raw data of a scanned object at each of time points during a scan;

determining three-dimensional coordinates of the scanned object at each of the time points based on the motion information at each of the time points;

performing data collation processing on the motion information at each of the time points based on the three-dimensional coordinates at each of the time points, to obtain processed motion information; and

obtaining a nuclear medicine image of the scanned object based on the processed motion information and the scanned raw data.

In some embodiments, the data collation processing includes merging processing; the processed motion information includes motion information in a plurality of sets; and performing the data collation processing on the motion information at each of the time points based on the three-dimensional coordinates at each of the time points, to obtain the processed motion information includes:

performing the merging processing on the motion information at each of the time points based on the three-dimensional coordinates at each of the time points, to obtain the plurality of sets.

In some embodiments, performing the merging processing on the motion information at each of the time points based on the three-dimensional coordinates at each of the time points, to obtain the plurality of sets includes classifying the time points into the plurality of sets. A distance between three-dimensional coordinates of any two time points within each of the sets is less than a first threshold.

In some embodiments, after performing the merging processing on the motion information at each of the time points based on the three-dimensional coordinates at each of the time points, to obtain the plurality of sets, the method further includes:

filtering the motion information in at least one of the sets, to obtain a plurality of target sets; and

obtaining the nuclear medicine image of the scanned object based on the processed motion information and the scanned raw data includes:

obtaining the nuclear medicine image of the scanned object based on motion information in the target sets and the scanned raw data.

In some embodiments, filtering the motion information in at least one of the sets, to obtain the plurality of target sets includes:

performing quality control on the motion information in at least one of the sets to obtain a quality control result; and

grouping the motion information in at least one of the sets based on the quality control result to obtain the plurality of the target sets.

In some embodiments, determining the three-dimensional coordinates of the scanned object at each of the time points based on the motion information at each of the time points includes:

determining a reference point of the scanned object; and

determining three-dimensional coordinates of the reference point at each of the time points based on the motion information at each of the time points.

In some embodiments, determining the three-dimensional coordinates of the reference point at each of the time points based on the motion information at each of the time points includes:

acquiring an initial spatial position of the reference point when the scan begins; and

calculating the three-dimensional coordinates of the reference point at each of the time points based on the initial spatial position and the motion information at each of the time points.

In some embodiments, before determining the three-dimensional coordinates of the scanned object at each of the time points based on the motion information at each of the time points, the method further includes:

determining corrected performance indicators of the scanned object at each of the time points based on the motion information and the scanned raw data at each of the time points;

performing screening processing on the motion information at each of the time points based on the corrected performance indicators, to obtain processed motion information;

obtaining a nuclear medicine image of the scanned object based on the processed motion information and the scanned raw data.

In some implementations, performing screening processing on the motion information at each of the time points based on the corrected performance indicators, to obtain processed motion information includes determining abnormal indicators from the corrected performance indicators; and performing the screening processing on the motion information based on the abnormal indicators, to obtain the processed motion information.

In some implementations, determining abnormal indicators from the corrected performance indicators includes acquiring reference indicators, and determining the abnormal indicators based on deviation values between the corrected performance indicators and the reference indicators.

In some implementations, the corrected performance indicators include at least one of motion corrected centroid of distribution (MCCOD) coordinates, or corrected count rate curves.

In some embodiments, acquiring the reference indicators includes: averaging the MCCOD coordinates at a plurality of time points, to obtain coordinate means as the reference centroid coordinates.

In some embodiments, the method further includes:

determining a plurality of motion free frames (MFFs) based on motion information at each of the time points, a distance between the three-dimensional coordinates at every two time points within each of the MFFs being less than a second threshold, and in two adjacent MFFs, a distance between three-dimensional coordinates at a last time point of a previous MFF and three-dimensional coordinates at a first time point of a subsequent MFF being greater than the second threshold; and

taking the plurality of MFFs as a plurality of frames obtained by classification.

In some embodiments, performing the screening processing on the motion information at each of the time points based on the corrected performance indicators, to obtain the processed motion information includes:

acquiring deviation values of coordinate means for the frames relative to the reference centroid coordinates;

screening out, from the plurality of frames, abnormal frames in which the corresponding deviation values do not conform to a predetermined deviation value; and

removing motion information at the plurality of time points within the abnormal frames from the motion information at each of the time points, to obtain the processed motion information.

In some embodiments, performing the screening processing on the motion information at each of the time points based on the corrected performance indicators, to obtain the processed motion information further includes:

acquiring deviation values of the MCCOD coordinates at each of the time points relative to the reference centroid coordinates; and

based on a predetermined percentage, removing motion information for which the deviation values do not conform to a predetermined deviation value, from the motion information at each of the time points, to obtain the processed motion information.

In some embodiments, the motion information at each of the time points is acquired in a first manner; and after performing the screening processing on the motion information at each of the time points based on the corrected performance indicators, to obtain the processed motion information, the method further includes:

determining abnormal time points corresponding to removed motion information;

determining new motion information corresponding to the abnormal time points in a second manner, and replacing the motion information corresponding to the abnormal time points with the new motion information, to obtain adjusted motion information of the scanned object; and

obtaining the nuclear medicine image of the scanned object based on the adjusted motion information, the processed motion information, and the scanned raw data.

The present disclosure provides a nuclear medicine image generation method. The method includes:

acquiring motion information and scanned raw data of a scanned object at each of time points during a scan;

determining motion corrected centroid of distribution (MCCOD) coordinates of the scanned object at each of the time points based on the motion information and scanned raw data at each of the time points;

determining reference centroid coordinates based on the MCCOD coordinates at each of the time points;

performing screening processing on the motion information at each of the time points based on the reference centroid coordinates, to obtain processed motion information; and

obtaining a nuclear medicine image of the scanned object, based on the processed motion information and the scanned raw data.

The present disclosure provides a nuclear medicine image generation apparatus. The apparatus includes:

an acquisition module configured to acquire motion information and scanned raw data of a scanned object at each of time points during a scan;

a determination module configured to determine three-dimensional coordinates of the scanned object at each of the time points based on the motion information at each of the time points;

a collation module configured to perform data collation processing on the motion information at each of the time points based on the three-dimensional coordinates at each of the time points, to obtain processed motion information; and

a generation module configured to obtain a nuclear medicine image of the scanned object based on the processed motion information and the scanned raw data.

In some embodiments, the data collation processing includes merging processing; the processed motion information includes motion information in a plurality of sets; and the collation module is further configured to perform the merging processing on the motion information at each of the time points based on the three-dimensional coordinates at each of the time points, to obtain the plurality of sets.

The present disclosure provides a computer device, including a memory and a processor, the memory storing a computer program, and the processor, when executing the computer program, performing steps of a nuclear medicine image generation method, including:

acquiring motion information and scanned raw data of a scanned object at each of time points during a scan;

determining three-dimensional coordinates of the scanned object at each of the time points based on the motion information at each of the time points;

performing data collation processing on the motion information at each of the time points based on the three-dimensional coordinates at each of the time points, to obtain processed motion information; and

obtaining a nuclear medicine image of the scanned object based on the processed motion information and the scanned raw data.

The present disclosure provides a computer-readable storage medium having a computer program stored therein. A processor, when executing the computer program, implements steps of the above-mentioned nuclear medicine image generation method.

### BRIEF DESCRIPTION OF THE DRAWINGS

In order to more clearly illustrate the technical solutions in embodiments of the present disclosure or the conventional art, the accompanying drawings used in the description of the embodiments or the conventional art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic flowchart of a nuclear medicine image generation method in some embodiments.

FIG. 2 is a schematic diagram of a merging condition when three-dimensional coordinates at respective time points are merged in some embodiments.

FIG. 3 is a schematic diagram of a variation curve of three-dimensional coordinates of a reference point over time and a variation curve of a Euclidean distance of the three-dimensional coordinates of the reference point relative to an initial spatial position at a scan start moment over time in some embodiments.

FIG. 4 is a schematic flowchart of a nuclear medicine image generation method in other embodiments.

FIG. 5 is a schematic flowchart of a nuclear medicine image generation method in some embodiments.

FIG. 6 is a schematic flowchart of a step of screening motion information at respective time points in some embodiments.

FIG. 7 is a schematic diagram of an MCCOD curve after motion information screening processing in some embodiments.

FIG. 8 is a schematic flowchart of a nuclear medicine image generation method in other embodiments.

FIG. 9 is a block diagram of a configuration of a nuclear medicine image generation apparatus in some embodiments.

FIG. 10 is a diagram of an internal configuration of a computer device in some embodiments.

### DETAILED DESCRIPTION

The technical solutions in embodiments of the present disclosure will be described clearly and completely below with reference to the accompanying drawings in the embodiments of the present disclosure. The described embodiments are merely some of rather than all of the embodiments of the present disclosure. All other embodiments acquired by those of ordinary skill in the art without creative efforts based on the embodiments of the present disclosure shall fall within the protection scope of the present disclosure.

To facilitate understanding of the present disclosure, an imaging principle of a PET imaging system is described below. It should be noted that the solution includes, but is not limited to, a PET system, and is further applicable to other medical systems such as SPECT. Before a PET image is scanned, a drug/tracer labeled with a radioactive element is first injected into a patient's body. During a PET scan, the drug/tracer emits a positron through decay, which annihilates with surrounding electrons to produce a pair of photons in opposite emission directions. On a condition that the two photons are simultaneously detected by detectors of the PET imaging system, an annihilation event is considered to occur on a connection line of a pair of detectors capturing the photons. The connection line is referred to as a line of response (LOR). A set of all LORs during the PET scan constitutes original data of the PET image. The PET imaging system typically employs a continuous scanning mode to acquire the original data to reconstruct the PET image.

Considering an influence of motion information, currently, during a nuclear medicine imaging scan, patient motion information may be acquired, and acquired patient motion information may be sent to an imaging device of a nuclear medicine imaging system. When a nuclear medicine image is generated, motion correction is performed on a reconstructed nuclear medicine image based on the patient motion information.

In a conventional workflow, a motion signal may be acquired through an external device or from acquired raw data of a nuclear medicine scan. When the patient motion information is acquired, a sampling rate plays a critical role. On a condition that a sampling rate of the motion signal is low, motion cannot be accurately detected, which affects a correction effect and further affects an image imaging effect. On a condition that the sampling rate of the motion signal is high, such as 1Hz or even 30Hz, motion information at a large number of moments may be acquired, resulting in substantial computational overhead for subsequent correction calculation. In addition, the motion information in some time segments of the acquired motion information is unreliable affected by a motion information acquisition manner, which consequently affects the correction effect.

Based on the above problems, the present disclosure provides a nuclear medicine image generation method, which identifies relatively static intervals through motion signals and merges the motion information, thereby ensuring a motion correction effect and reducing an amount of calculation.

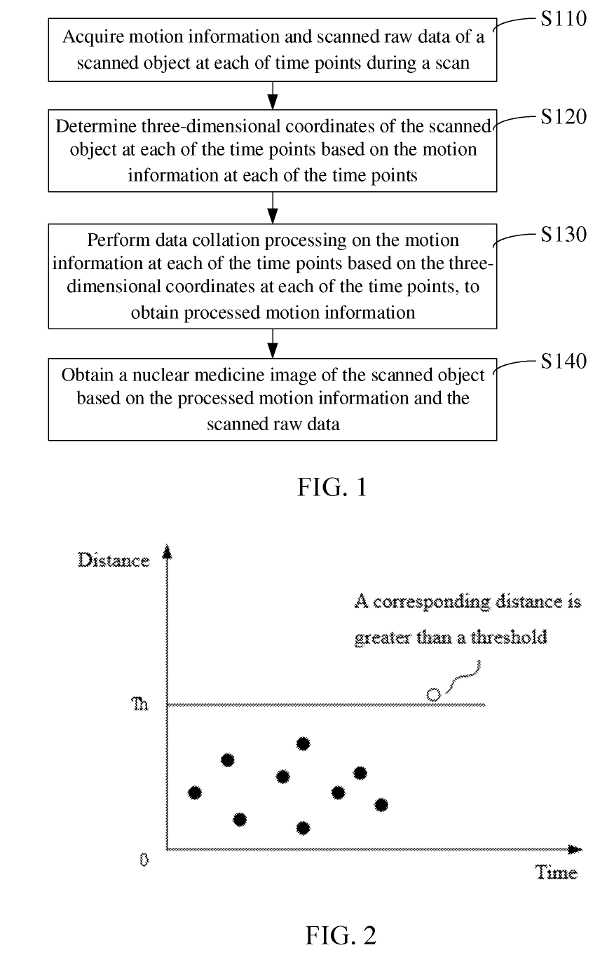

Refer to FIG. 1, which is a schematic flowchart of a nuclear medicine image generation method in some embodiments of the present disclosure. This embodiment is illustrated based on an example in which the method is applied to a terminal. It may be understood that the method is also applicable to a server, and is further applicable to a system including a terminal and a server, and is implemented through interaction between the terminal and the server. The terminal may include, but is not limited to, various personal computers, notebook computers, smartphones, tablet computers, Internet of Things devices, and portable wearable devices. The Internet of Things devices may be smart speakers, smart televisions, smart air conditioners, smart vehicle-mounted devices, or the like. The portable wearable devices may be smart watches, smart bracelets, head-mounted devices, or the like. The server may be implemented as a standalone server or a server cluster including a plurality of servers. In this embodiment, the method includes steps S110 to S140.

In step S110, motion information and scanned raw data of a scanned object at each of time points during a scan are acquired.

The scanned object refers to a moving living object or a moving part of a living object. For example, the scanned object may be the head, a limb, or the like, of a human body.

The motion information refers to rigid motion information, such as head motion or limb motion, which may be represented by a rigid body motion matrix.

In specific implementation, the motion information of the scanned object at each of the time points during the scan may be acquired by an external device of a nuclear medicine imaging device, such as an image recording device (e.g., a structured-light camera), a scanner, or a tracker, may be obtained from other external signals, or may be calculated based on scanned raw data acquired from nuclear medicine image scanning.

In a PET scenario, the scanned raw data may include a set of all LORs during the scan. In an SPECT scenario, the scanned raw data may include a set of single-photon counts and position information acquired by a detector. The scanned raw data are original data for subsequent generation of a nuclear medicine image.

In step S120, three-dimensional coordinates of the scanned object at each of the time points are determined based on the motion information at each of the time points.

In specific implementation, after the motion information of the scanned object at each of the time points is acquired and before the three-dimensional coordinates of the scanned object at each of the time points are determined, an initial spatial position of the scanned object when the scan begins may be first determined, and then the three-dimensional coordinates of the scanned object at each of the time points are determined based on the motion information at each of the time points by taking the initial spatial position as a reference point.

In step S130, data collation processing is performed on the motion information at each of the time points based on the three-dimensional coordinates at each of the time points, to obtain processed motion information.

In specific implementation, the data collation processing includes at least one of merging processing and screening processing. The merging processing may involve grouping time points with similar motion states into a set to reduce an amount of calculation. The screening processing may involve removing abnormal motion information to ensure accuracy. For example, merging processing is performed on the three-dimensional coordinates at each of the time points, to identify relatively static time intervals, thereby merging the motion information. Therefore, through differences between the three-dimensional coordinates at each of the time points (which may specifically be distances), the processed motion information may be obtained by performing the merging processing on the three-dimensional coordinates at each of the time points based on the distances. The processed motion information may include a plurality of sets. For example, screening processing may be performed on the motion information at each of the time points based on the three-dimensional coordinates at each of the time points, to obtain the processed motion information. Through the data collation processing, redundant information and erroneous information in the motion information at each of the time points can be removed, thereby reducing the amount of calculation and improving the accuracy.

It may be understood that when distances between the three-dimensional coordinates at two time points are almost the same, they may be considered to be in a relatively static state. Therefore, by setting a threshold, time points at which the distances between the three-dimensional coordinates are less than the threshold may be classified into a same set. In a plurality of sets obtained therefrom, the scanned object is relatively static at time points corresponding to each set. Distances between the three-dimensional coordinates at different time points may be Euclidean distances. On a merging condition that the distances between the three-dimensional coordinates are less than the threshold, the respective time points are traversed, and the three-dimensional coordinates at each of the time points are merged, to obtain a plurality of sets.

In practical applications, the three-dimensional coordinates may be clustered by using a clustering algorithm (e.g., point cloud clustering), and adjacent points are classified into a same cluster. For the three-dimensional coordinates in each set, the differences therebetween are calculated, and it is ensured that the differences meet a predetermined condition, such as the distances being less than the threshold.

In step S140, a nuclear medicine image of the scanned object is obtained based on the processed motion information and the scanned raw data.

In specific implementation, after merging the motion information at each of the time points is completed, the scanned raw data are corrected through the motion information, to compensate for an influence caused by motion. Specifically, the scanned raw data may be corrected by using a motion correction algorithm. Image generation is performed based on processed scanned raw data by using a nuclear medicine image generation algorithm.

Further, after the nuclear medicine image of the scanned object is generated and obtained, post-processing, such as denoising and filtering, may be performed on the nuclear medicine image to further enhance image quality and clarity.

In the nuclear medicine image generation method above, through the motion information at each of the time points, the three-dimensional coordinates of the scanned object at each of the time points are determined and the motion information is merged based on the coordinates, so that a motion situation of the scanned object can be captured more accurately. By performing the merging processing on the motion information to group time points with similar motion patterns into a set, a volume of data required to be processed is reduced, thereby reducing computational overhead of subsequent correction calculation and improving computational efficiency. Meanwhile, by generating the nuclear medicine image of the scanned object based on the motion information in each set in conjunction with the scanned raw data, motion-induced image blurring and offset can be effectively reduced, thereby enhancing an effect of the generated image and obtaining a high-quality nuclear medicine image. Consequently, the problem in existing methods that it is difficult to strike a balance between the motion correction effect and the computational efficiency, is solved.

In some embodiments, performing the merging processing on the motion information at each of the time points based on the three-dimensional coordinates at each of the time points, to obtain the plurality of sets includes classifying the time points into the plurality of sets, a distance between three-dimensional coordinates of any two time points within each of the sets being less than a first threshold.

In an exemplary embodiment, in step S130 above, performing the merging processing on the motion information at each of the time points based on the three-dimensional coordinates at each of the time points, to obtain the plurality of sets may specifically be implemented through the following steps:

determining an initial reference time point from the time points;

acquiring distances between three-dimensional coordinates at other time points in the time points and at the initial reference time point, and classifying motion information at time points, at which the corresponding distances are less than a first threshold, in the other time points into a set corresponding to the initial reference time point; and

selecting a new reference time point from the remaining time points, and performing re-merging processing based on distances between three-dimensional coordinates at other time points in the remaining time points except the new reference time point and at the new reference time point, until the three-dimensional coordinates at all the time points are traversed, to obtain the plurality of sets.

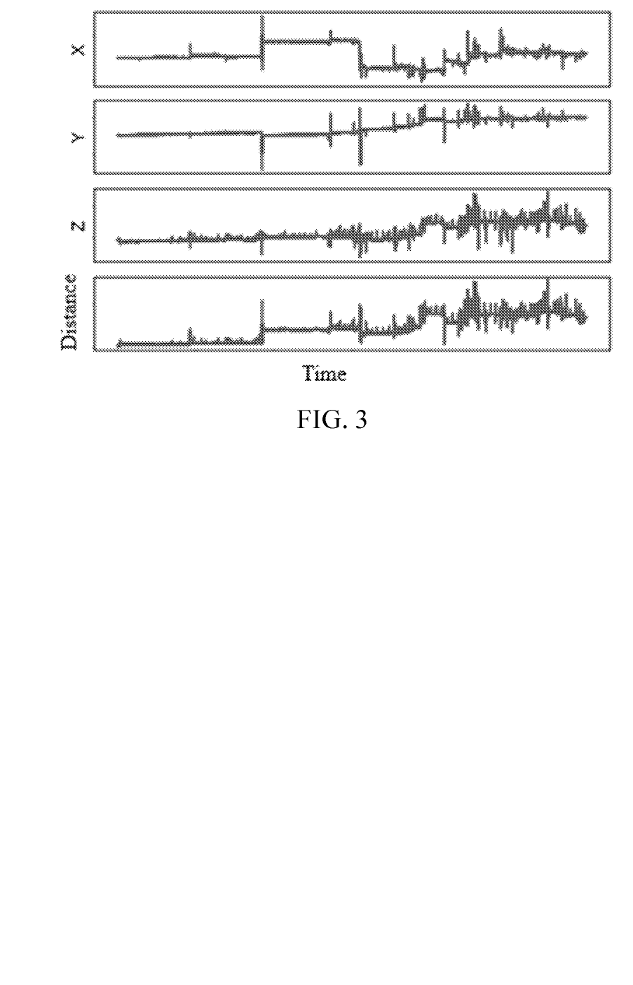

In specific implementation, the first time point in the remaining time points may be selected in chronological order as the new reference time point, or a time point closest to a mean distance may be selected as the new reference time point. When the three-dimensional coordinates at each of the time points are merged, one or more reference time points may be selected as a cluster center, distances of the three-dimensional coordinates at other time points relative to the cluster center are calculated, and clustering is implemented on a merging condition of whether the distances are less than a first threshold. FIG. 2 is a schematic diagram of the merging condition. In FIG. 2, Th denotes the first threshold. The motion information at each time point is traversed until the motion information at all the time points is classified into corresponding sets, to obtain the plurality of sets.

To facilitate understanding, this embodiment is described below based on an example in which one reference time point is selected at a time:

(1) Firstly, one time point is randomly selected from the respective time points as an initial reference time point, and three-dimensional coordinates at the initial reference time point are denoted as Pr.

(2) Distances dn between three-dimensional coordinates Pn at other time points except the initial reference time point and the three-dimensional coordinates Pr at the initial reference time point are calculated.

(3) On a condition that a distance di corresponding to a time point i is less than the first threshold (e.g., 1mm), indicating that a motion state of the scanned object at the time point is consistent with that at the initial reference time point, motion information at the time point i and the initial reference time point is recorded in a same set. Conversely, on a condition that the distance di corresponding to the time point i is greater than or equal to the first threshold, merging operation will not be performed. By analogy, a determination of whether a merging operation is required is performed on all other time points except the initial reference time point, to obtain a set corresponding to the initial reference time point.

(4) A new reference time point is selected from the remaining time points not classified into the set corresponding to the initial reference time point, distances between the three-dimensional coordinates at other time points in the remaining time points except the new reference time point and at the new reference time point are calculated, and on a merging condition that the distance is less than the first threshold, another round of determination of whether a merging operation is required is performed, to obtain a set corresponding to the new reference time point.

(5) For the remaining time points not classified into the set corresponding to the initial reference time point and the set corresponding to the new reference time point, a new reference time point is selected for the third time, and step (4) is repeated until the three-dimensional coordinates at all the time points are assigned to sets, to obtain the plurality of sets.

In this embodiment, by merging the time points at which the distances between the three-dimensional coordinates are less than the first threshold into a same set, relatively static time intervals are identified, thereby facilitating the merging of the motion information. Data within static time intervals include less motion information, and thus can be processed into a more practical form to reduce complexity and resource consumption of subsequent processing.

In an exemplary embodiment, subsequent to step S130 of performing the merging processing on the motion information at each of the time points based on the three-dimensional coordinates at each of the time points, to obtain the plurality of sets, the method further includes: filtering the motion information in each set separately, to obtain a plurality of target sets.

Correspondingly, step S140 of obtaining the nuclear medicine image of the scanned object based on the processed motion information and the scanned raw data includes: obtaining the nuclear medicine image of the scanned object based on motion information in the target sets and the scanned raw data.

In specific implementation, after performing the merging processing on the motion information at each of the time points based on the three-dimensional coordinates at each of the time points, to obtain the plurality of sets, quality control may be performed on the motion information in each set, and the motion information in each set may be filtered based on a quality control result.

Specifically, in an implementation, for each set, motion information at respective time points in the set may be filtered based on three-dimensional coordinates at each of the time points in the set. A quality control method employed may include clustering, similarity, mathematical model fitting, outlier analysis, and the like, thereby further ensuring the similarity between the motion information in each set. Correspondingly, subsequent to filtering the motion information in each set separately, to obtain the plurality of target sets, the nuclear medicine image of the scanned object is obtained based on filtered motion information in the target sets and the scanned raw data.

In another implementation, the motion information in the sets may alternatively be removed based on time. For example, on a condition that two time points that are not far apart belong to a same set and an intermediate time point corresponds to another set, motion information at the intermediate time point may be directly removed, and the motion information on two sides may be merged. On a condition that two time points are far apart and a data volume in the same set near the two time points is sufficient, the set may be split into two sets. In specific implementation, for each set, motion information at continuous time points in the set may be retained, and motion information at discontinuous time points may be removed. For example, on a condition that time points corresponding to motion information in one set are respectively: 8:00, 8:01, 8:02, 8:03, 8:10, and 8:15, the motion information at the time points 8:00 to 8:03 may be retained, while the motion information at the time points 8:10 and 8:15 may be removed. On a condition that the time points corresponding to the motion information in a set may form a plurality of continuous frames, the longer frames may be retained while the shorter frames may be removed. For example, on a condition that time points corresponding to motion information in one set are respectively: 8:00, 8:01, 8:02, 8:03, 8:10, and 8:11, the motion information at the time points 8:00 to 8:03 may be retained, while the motion information at the time points 8:10 and 8:11 may be removed. It is to be noted that the processing methods for removing the motion information at discontinuous time points and retaining the longer frames while removing the shorter frames may be used in combination or individually. A selection may be made specifically based on an actual situation in each set.

In this embodiment, by performing the screening processing on the motion information in each set, quality control on the motion information in the sets is achieved, which further ensures the consistency between the motion states represented by the motion information in each target set. Consequently, quality and efficiency of the nuclear medicine image of the scanned object obtained based on the screened motion information in each target set and the scanned raw data can be enhanced.

In some embodiments, filtering the motion information in at least one of the sets, to obtain the plurality of target sets includes: performing quality control on the motion information in at least one of the sets to obtain a quality control result, and grouping the motion information in at least one of the sets based on the quality control result to obtain the plurality of the target sets.

Specifically, the quality control includes at least one of similarity calculation, mathematical model fitting, and outlier analysis. For example, the quality control may be optional. In the field of PET (Positron Emission Tomography), accurate classification of motion information is crucial for improving imaging quality and diagnostic accuracy. Secondary quality control of motion position sets is a key step to ensure the accuracy of motion information classification, which can be performed using methods such as similarity calculation, mathematical model fitting, and outlier analysis. In PET imaging, similarity calculation can be used to evaluate the similarity between PET images in different frames or under different motion states, so as to judge the rationality of motion position sets. For example, by calculating the similarity between a reference PET image and a PET image to be corrected, which uses indicators such as mutual information and mean squared error, the accuracy of motion information is determined. On a condition that the similarity between the two images is low, it may indicate a problem with the classification of motion information, which requires further adjustment. In PET imaging, motions such as respiratory motion can cause image errors, and mathematical model fitting can be used to estimate such motions. For instance, a respiratory motion model is established based on initial MR (Magnetic Resonance) scanned raw data, and this model is configured to constrain the registration between PET images. The reference PET gated image and the gated image to be corrected are registered through the motion model. By continuously adjusting the model parameters, the highest similarity of the registered images is achieved, thereby obtaining accurate motion information and realizing quality control of motion position sets.

Further, in an exemplary embodiment, filtering the motion information in at least one of the sets, to obtain the plurality of target sets, is specifically implemented through the following steps:

performing quality control on the motion information in at least one of the sets to obtain a quality control result; and

grouping the motion information in at least one of the sets based on the quality control result to obtain the plurality of the target sets.

In specific implementation, for each set, a process of filtering the motion information in the set is: clustering the motion information in a set based on the three-dimensional coordinates at each time point in the set, and classifying the motion information into different clusters based on similarities between the corresponding three-dimensional coordinates. A clustering algorithm employed may be K-means clustering or the like, which is not specifically limited in the present disclosure. A clustering result obtained by clustering may include one cluster or may include a plurality of clusters. On a condition that the clustering result includes only one cluster, outlier motion information located outside the cluster may be detected and removed. On a condition that the clustering result includes a plurality of clusters, for clusters with a smaller data volume, removal thereof may be considered to ensure a sufficient data volume in the target set, thereby facilitating subsequent image generation. The above steps are repeated for each set, to obtain a target set corresponding to each set.

In this embodiment, the motion information in each set is filtered to obtain a plurality of target sets, which can enhance data quality, simplify a data analysis process, and ultimately improve quality and accuracy of the nuclear medicine image.

In an exemplary embodiment, step S120 of determining the three-dimensional coordinates of the scanned object at each of the time points based on the motion information at each of the time points includes: determining a reference point of the scanned object; and determining three-dimensional coordinates of the reference point at each of the time points based on the motion information at each of the time points.

Specifically, to effectively track motion of the scanned object in the nuclear medicine image, a reference point may be determined prior to determining the three-dimensional coordinates of the scanned object at each of the time points based on the motion information at each of the time points. The reference point should be relatively stable and may be a physiological feature point of the scanned object, for example, a specific structure of the head (such as a center point of the forehead) is taken as the reference point, which cannot be an unfixed point, such as a point on the hair, to ensure accurate tracking of the motion of the scanned object and guarantee an effect of subsequent motion correction.

After the reference point is determined, the motion of the scanned object is represented with motion at the reference point. For each time point, the three-dimensional coordinates of the reference point at the time point are calculated through the motion information of the scanned object at the time point.

The scanned object may have one or more reference points. For example, the scanned object is the head, and the reference point may be a center point of the forehead or a center between two brow bones. Moreover, the reference point of the scanned object may be obtained through an external device, or positioned through a nuclear medicine image, a CT image, or the like, or set based on experience.

In this embodiment, by determining the reference point, a stable reference marker for tracking the motion of the scanned object is provided, to compare and track positions of the scanned object at different time points, which provides accurate motion trajectory information, facilitates subsequent effective motion correction, eliminates motion-induced artifacts or distortions, and improves accuracy and clarity of the nuclear medicine image.

In an exemplary embodiment, the above step of determining the three-dimensional coordinates of the reference point at each of the time points based on the motion information at each of the time points includes: acquiring an initial spatial position of the reference point when the scan begins; and calculating the three-dimensional coordinates of the reference point at each of the time points based on the initial spatial position and the motion information at each of the time points.

Specifically, by taking head acquisition as an example and taking the center point of the forehead as the reference point, the initial spatial position of the center point of the forehead is identified through a camera recognition technology when the scan begins (a first moment), because motion information of the head at different time points (represented by a rigid body motion matrix) may be obtained through binocular imaging of a three-dimensional camera. Therefore, by combining the initial spatial position of the center point of the forehead with the motion information at each time point, a positional change of the center point of the forehead over time can be calculated.

It may be understood that the motion information at each time point is represented by a rigid body motion matrix, and the rigid body motion matrix includes position information and attitude information. Calculating the three-dimensional coordinates of the reference point at each of the time points based on the initial spatial position and the motion information at each of the time points may specifically be multiplying the motion information at each time point by the initial spatial position to obtain the corresponding three-dimensional coordinates.

Refer to FIG. 3 which is a schematic diagram of a variation curve of three-dimensional coordinates (X, Y, Z) of the reference point over time (which may be denoted as a time-position curve, TPC) and a variation curve of a Euclidean distance of the three-dimensional coordinates of the reference point relative to the initial spatial position at a scan start moment (i.e., initial three-dimensional coordinates) over time (which may be denoted as a time-distance curve, TDC), from which a motion trajectory and positional changes of the reference point during the scan can be seen.

In this embodiment, by combining the initial spatial position of the reference point when the scan begins with the motion information at each of the time points, accurate three-dimensional coordinate information of the reference point at different time points during the scan can be obtained, which reflects a motion trajectory and positional changes of the reference point. The three-dimensional coordinate information may be used to dynamically correct the nuclear medicine image, and eliminate motion-induced artifacts or distortions, thereby enhancing image quality and accuracy.

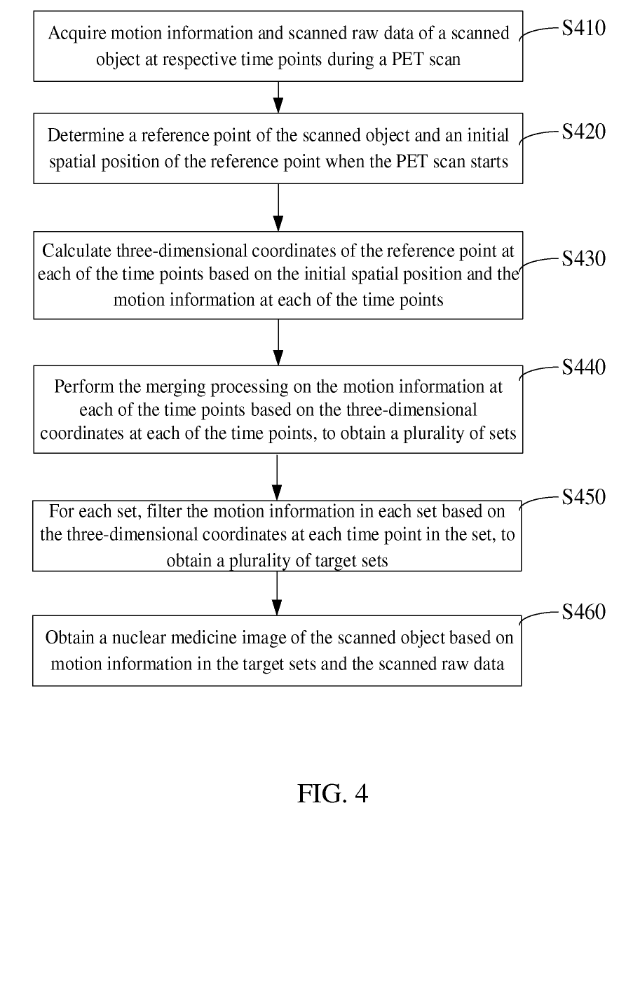

In some embodiments, to facilitate those skilled in the art to understand the embodiments of the present disclosure, the following description will be provided with reference to specific examples in the accompanying drawings. Refer to FIG. 4, which is a specific schematic flowchart of a nuclear medicine image generation method illustrated based on an example in which the nuclear medicine image is a PET image. In this embodiment, the following steps are included.

In step S410, motion information and scanned raw data of a scanned object at respective time points during a PET scan are acquired.

In step S420, a reference point of the scanned object and an initial spatial position of the reference point when the PET scan starts are determined.

In step S430, three-dimensional coordinates of the reference point at each of the time points are calculated based on the initial spatial position and the motion information at each of the time points.

In step S440, the merging processing is performed on the motion information at each of the time points based on the three-dimensional coordinates at each of the time points, to obtain a plurality of sets.

In step S450, for each set, the motion information in each set is filtered based on the three-dimensional coordinates at each time point in the set, to obtain a plurality of target sets.

In step S460, a nuclear medicine image of the scanned object is obtained based on motion information in the target sets and the scanned raw data.

In this embodiment, by estimating actual motion amplitude of the scanned object during PET acquisition through motion information in combination with physiological feature points, acquired data may be segmented and merged based on motion conditions, which can ensure an effect of motion correction and improve computational efficiency.

It should be understood that, although the steps in the flowchart as referred to in the embodiments as described above are shown in sequence as indicated by the arrows, the steps are not necessarily performed in the order indicated by the arrows. Unless otherwise clearly specified herein, the steps are performed without any strict sequence limitation, and the steps may be performed in other orders. In addition, at least some steps in the flowchart as referred to in the embodiments as described above may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately.

In ECT-based nuclear medicine imaging research, due to a relatively long scanning time of the nuclear medicine imaging device, the scanned object is prone to motion during the scan. The motion may lead to problems such as image artifacts and inaccurate quantification, thereby affecting subsequent diagnosis. Therefore, typically, motion information may be acquired during a nuclear medicine scan to perform motion correction.

In the related art, generally, a set of motion information for describing a motion condition of the scanned object within an acquisition frame is acquired, and a nuclear medicine image is reconstructed in combination with the motion information, to achieve motion correction. However, the motion information in some time segments is unreliable affected by the motion information acquisition manner, which may consequently affect an effect of a reconstructed image.

The present disclosure provides a nuclear medicine image generation method, which can identify discontinuous time segments where a centroid of distribution (COD) exhibits significant deviations, jumps, or the like. By processing the time segments, more accurate motion information is obtained, thereby achieving a better motion correction effect.

COD (Centroid-of-Distribution) is a key signal indicator used to evaluate the motion correction effect during the imaging process in the field of PET. Its core function is to judge and optimize the quality of PET images by tracking the position change of the "center of gravity" of the tracer distribution, and it is widely used especially in brain PET imaging.

During PET scans (such as brain scans), slight movements of the subject (such as head shaking) will cause blurring of the tracer distribution and reduce image resolution. The COD signal will record the real-time trajectory of the center of gravity of the tracer distribution without motion correction, intuitively reflecting the degree of motion interference on imaging.

To offset the impact of motion, a motion correction algorithm is used to generate MCCOD (Motion Corrected Centroid-of-Distribution). By comparing the original COD trajectory (usually with large fluctuations) with the MCCOD trajectory (more stable under ideal conditions), it is possible to directly judge whether the motion correction algorithm is effective and whether the corrected image accurately restores the tracer distribution.

In the field of PET, the count rate curve is obtained by processing and counting the signals detected by the detector, and it can provide an important basis for the quality control of motion information during the PET imaging process. When a PET device scans a detected object, the detector detects γ photons generated by positron annihilation, and the count rate refers to the number of γ photons detected by the detector. By performing real-time processing on the scanned raw data and counting the number of counts per unit time, a count rate curve that reflects the change of count rate with time can be generated. A count rate curve model under normal conditions is established, and this model can be determined based on a large amount of normal scanned raw data or based on the characteristics and theoretical model of the PET device. During the actual scanning process, the real-time generated count rate curve is compared with the normal curve model. If there are significant differences between the characteristics of the curve (such as shape, amplitude, period) and the normal curve, it may indicate that the patient has abnormal movements or the device is in an abnormal operating state, requiring further inspection and handling to ensure the quality of the PET image.

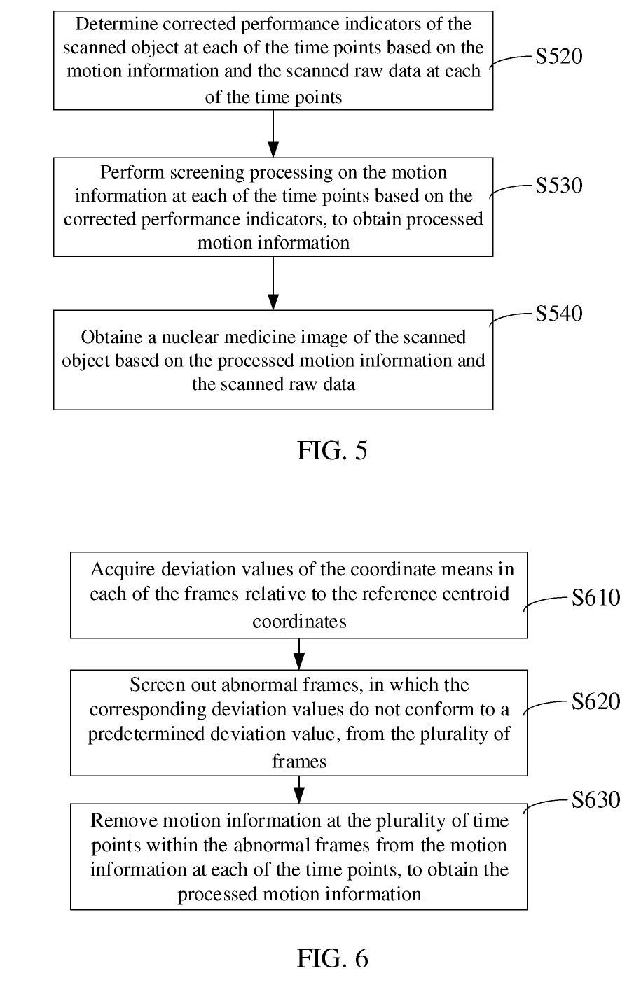

Refer to FIG. 5 which is a schematic flowchart of a nuclear medicine image generation method in some embodiments of the present disclosure. This embodiment is illustrated based on an example in which the method is applied to a terminal. It may be understood that the method is also applicable to a server, and is further applicable to a system including a terminal and a server and is implemented through interaction between the terminal and the server. The terminal may include, but is not limited to, various personal computers, notebook computers, smartphones, tablet computers, Internet of Things devices, and portable wearable devices. The Internet of Things devices may be smart speakers, smart televisions, smart air conditioners, smart vehicle-mounted devices, or the like. The portable wearable devices may be smart watches, smart bracelets, head-mounted devices, or the like. The server may be implemented as a standalone server or a server cluster including a plurality of servers.

In some embodiments, after acquiring the motion information and the scanned raw data of the scanned object at each of time points during the scan, the method further includes steps S520 to S540.

In step S520, corrected performance indicators of the scanned object at each of the time points are determined based on the motion information and the scanned raw data at each of the time points.

Specifically, MCCOD coordinates of the scanned object at each of the time points are determined based on the motion information and the scanned raw data at each of the time points.the scanned raw data include a set of all LORs during the nuclear medicine scan. Therefore, the scanned raw data include LORs for all events corresponding to the respective time points. The process of determining the MCCOD coordinates of the scanned object at each of the time points based on the motion information and the scanned raw data at each of the time points may include: for each time point, performing, based on the motion information at the time point, motion correction on an LOR in the scanned raw data corresponding to the time point, to obtain a corrected LOR. Back projection and sensitivity correction are performed on the corrected LOR, forming a point-cloud image at the time point, which serves as an approximation of a tracer distribution image. Then, a COD at the time point is calculated based on the point-cloud image, to obtain MCCOD coordinates at the time point. On a condition that the motion of the scanned object is a rigid motion, COD coordinates at each time point are an average value of coordinate values of the scanned object in directions X, Y, and Z at the time point.

In specific implementation, reference centroid coordinates are acquired. The reference centroid coordinates may be determined based on the MCCOD coordinates at each of the time points, which may be determined, for example, from a dimension of a single time point, or from a dimension of a frame including a plurality of time points.

When the reference centroid coordinates are determined from a dimension of a single time point, statistical methods may be employed to count means, medians, or the like, serving as the reference centroid coordinates. Specifically, the MCCOD coordinates at each of the time points may be processed by calculating a mean or a median, to obtain the reference centroid coordinates. Alternatively, a clustering analysis method may be adopted to cluster the MCCOD coordinates at each of the time points, and centroid coordinates obtained from clustering are used as the reference centroid coordinates. The reference centroid coordinates may alternatively be determined by using a neural network.

When the reference centroid coordinates are determined from a dimension of a frame, the respective time points may be classified into a plurality of frames. For each frame, the reference centroid coordinates are determined once for the MCCOD coordinates within the frame, which are denoted as local reference centroid coordinates in the frame. Then, overall reference centroid coordinates are determined based on the local reference centroid coordinates in the frame. The method for determining reference centroid coordinates in a frame and determining overall reference centroid coordinates based on the reference centroid coordinates in the frame follows a same principle as the above method for determining the reference centroid coordinates from a dimension of a single time point. Similarly, methods such as a statistical method, a clustering analysis method, and a neural network may also be adopted. Details are not described herein again.

The data collation processing includes screening processing. Performing the data collation processing on the motion information at each of the time points based on the three-dimensional coordinates at each of the time points, to obtain the processed motion information.

In step S530, screening processing is performed on the motion information at each of the time points based on the corrected performance indicators, to obtain processed motion information.

In some embodiments, performance indicators of the scanned object at each of the time points, such as COD signals or count rate curves, are obtained based on the scanned raw data. The performance indicators are corrected based on the motion information to obtain corrected performance indicators.

In some implementations, performing screening processing on the motion information at each of the time points based on the corrected performance indicators, to obtain processed motion information includes determining abnormal indicators from the corrected performance indicators; and performing the screening processing on the motion information based on the abnormal indicators, to obtain the processed motion information.

In some implementations, determining abnormal indicators from the corrected performance indicators includes acquiring reference indicators, and determining the abnormal indicators based on deviation values between the corrected performance indicators and the reference indicators.

In some implementations, the corrected performance indicators include at least one of motion corrected centroid of distribution (MCCOD) coordinates, or corrected count rate curves.

In some implementations, screening processing is performed on the motion information at each of the time points based on the reference centroid coordinates and the MCCOD coordinates, to obtain the processed motion information. the reference centroid coordinates may be determined from a dimension of a single time point or from a dimension of a frame. Correspondingly, screening processing performed on the motion information at each of the time points based on the reference centroid coordinates and the MCCOD coordinates may also be determined from a dimension of a time point and a dimension of a frame.

Specifically, when the reference centroid coordinates are determined from a dimension of a time point, screening processing on the motion information at each of the time points based on the reference centroid coordinates and the MCCOD coordinates is also performed from a dimension of a time point, i.e., by determining whether deviation values between the MCCOD coordinates at each time point and the reference centroid coordinates conforms to a predetermined deviation value, abnormal time points required to be removed are determined, which achieves screening of the motion information at each of the time points, to obtain the processed motion information.

When the reference centroid coordinates are determined from a dimension of a frame, screening processing on the motion information at each of the time points based on the reference centroid coordinates and the MCCOD coordinates may be performed from a dimension of a frame or from a dimension of a time point. The method in terms of execution from a dimension of a time point is the same as the method described above. Details are not described herein again. In terms of execution from a dimension of a frame, by taking each frame as a unit, abnormal time points required to be removed are determined based on whether deviation values between local reference centroid coordinates in the frame and overall reference centroid coordinates conforms to a predetermined deviation value, which achieves screening of the motion information at each of the time points, to obtain the processed motion information.

In step 540, a nuclear medicine image of the scanned object is obtained based on the processed motion information and the scanned raw data.

Further, after screening processing on the motion information at each of the time points is completed, the motion information may be corrected through obtaining the processed motion information, to compensate for an influence caused by motion. Specifically, the scanned raw data may be corrected by using a motion correction algorithm. Image generation is performed based on processed scanned raw data by using a nuclear medicine image generation algorithm.

Further, after the nuclear medicine image of the scanned object is generated, post-processing, such as denoising and filtering, may be performed on the nuclear medicine image to further enhance image quality and clarity.

In the above nuclear medicine image generation method, after the motion information and the scanned raw data of the scanned object at each of the time points during the scan are acquired, MCCOD coordinates of the scanned object at each of the time points are determined based on the motion information and the scanned raw data at each of the time points, and reference centroid coordinates are acquired. Consequently, by performing the screening processing on the motion information at each of the time points based on the reference centroid coordinates and the MCCOD coordinates, unreliable motion information can be effectively identified and removed, which enhances accuracy and reliability of the obtained processed motion information, thereby improving image quality of the nuclear medicine image of the scanned object generated from the scanned raw data and ensuring a motion correction effect. Moreover, when centroid coordinates of the scanned object at each of the time points are determined, the centroid coordinates are determined based on the motion information, and correction of the centroid coordinates can be achieved through the motion information, to obtain MCCOD coordinates, which ensures accuracy of the determined centroid coordinates, thereby helping to accurately correct motion-induced image artifacts.

In some embodiments, a nuclear medicine image generation method is provided in the present disclosure. The method includes: acquiring motion information and scanned raw data of a scanned object at each of time points during a scan; determining motion corrected centroid of distribution (MCCOD) coordinates of the scanned object at each of the time points based on the motion information and scanned raw data at each of the time points; determining reference centroid coordinates based on the MCCOD coordinates at each of the time points; performing screening processing on the motion information at each of the time points based on the reference centroid coordinates, to obtain processed motion information; and obtaining a nuclear medicine image of the scanned object, based on the processed motion information and the scanned raw data. For specific limitations in one or more embodiments of the nuclear medicine image generation method provided herein, refer to the limitations of the method above. Details are not described herein again.

In some embodiments, step S130 of acquiring the reference indicators includes averaging the MCCOD coordinates at a plurality of time points, to obtain coordinate means as reference centroid coordinates.

Specifically, acquiring the reference indicators includes:

classifying the respective time points into a plurality of frames;

for each frame, averaging the MCCOD coordinates at a plurality of time points within the frames, to obtain coordinate means for the frames; and averaging the coordinate means in the plurality of frames, and taking resulting average coordinates as the reference centroid coordinates.

In specific implementation, the respective time points are classified into a plurality of frames. A plurality of time points within a frame are continuous, i.e., the frames are required to be divided in chronological order of the time points. For example, a plurality of frames are obtained in a manner of classifying every 5 time points into 1 frame in chronological order without overlapping. Time lengths of the frames obtained by classification may be the same or different. Durations of the frames are not specifically limited.

More specifically, on the basis of obtaining the frames by classification in chronological order of the time points, random classification may be performed, i.e., the frames may be obtained by classification by using random durations or based on a fixed predetermined duration. It may be further set that motion states represented by the motion information within a frame are consistent. In other words, distances between MCCOD coordinates at every two time points within the frame are very close.

After a plurality of frames are obtained by classification, for each frame, the MCCOD coordinates at a plurality of time points within the frame may be first averaged, to obtain a coordinate mean in the frame. Then, the coordinate mean in the frame is averaged, and resulting average coordinates are taken as the reference centroid coordinates.

In this embodiment, by classifying the respective time points into a plurality of frames, data fluctuations across the time points can be smoothed to some extent, which helps to remove some noise and outliers, so that the obtained reference centroid coordinates are more stable and reliable. Further, through multi-stage averaging processing, transient fluctuations within certain frames can be eliminated, and the likelihood that the reference centroid coordinates deviate from a true value due to error accumulation can be reduced, thereby further enhancing the accuracy and reliability of the reference centroid coordinates.

In an exemplary embodiment, classifying the respective time points into the plurality of frames includes: determining a plurality of MFFs based on the motion information at each of the time points; and taking the plurality of MFFs as the plurality of frames obtained by classification.

A distance between three-dimensional coordinates at every two time points within each of the MFFs is less than a second threshold, and in two adjacent MFFs, a distance between three-dimensional coordinates at a last time point of a previous MFF and three-dimensional coordinates at a first time point of a subsequent MFF is greater than the second threshold.

In specific implementation, an MFF may be understood as a relatively static frame without significant motion. The time points within the frame have relatively consistent MCCOD coordinates. Therefore, when the MFFs are determined based on the MCCOD coordinates at each of the time points, the distance between the MCCOD coordinates at every two time points may be first calculated, and according to a predetermined second threshold, the respective time points at which the corresponding distances are less than the second threshold are classified into a same frame, thereby obtaining a plurality of frames. Further, since the time points within each frame have temporal continuity, after the plurality of frames are obtained, quality control may be further performed on each frame to check and remove discontinuous and isolated time points from the corresponding frame. For example, on a condition that the distance between three-dimensional coordinates corresponding to two adjacent time points is greater than the second threshold, there is a jump between these two time points. That is, a latter time point of the two time points needs to be removed from the current MFF, thereby obtaining a plurality of MFFs. Specifically, for two adjacent MFFs of the plurality of MMFs, a distance between three-dimensional coordinates at a last time point of a previous MFF and three-dimensional coordinates at a first time point of a subsequent MFF is greater than the second threshold.

The plurality of MFFs are taken as the plurality of frames obtained by classification. For each frame, the MCCOD coordinates at the plurality of time points within the MFF are averaged, to obtain a coordinate mean in each MFF. Finally, the coordinate mean in each MFF is averaged, and resulting average coordinates are taken as the reference centroid coordinates.

It may be understood that determining the plurality of MFFs based on the MCCOD coordinates at each of the time points may alternatively be performed with another method, such as a clustering method or other methods that can identify similar data, which is not specifically limited in the present disclosure.

In this embodiment, by classifying the respective time points into a plurality of MFFs, interference caused by data noise or outliers can be reduced, and data volatility can be diminished, so that the reference centroid coordinates determined based on the plurality of MFFs are more stable and representative.

It may be understood that acquiring the reference centroid coordinates may be determined from a dimension of a single time point, or from a dimension of a frame including a plurality of time points. Correspondingly, screening processing performed on the motion information at each of the time points based on the reference centroid coordinates and the MCCOD coordinates may also be performed from a dimension of a single time point or from a dimension of a frame.

When screening is performed from a dimension of a frame, correspondingly, in an exemplary embodiment, as shown in FIG. 6, step S530 of performing the screening processing on the motion information at each of the time points based on the corrected performance indicators, to obtain the processed motion information includes steps S610 to S630.

In step S610, deviation values of the coordinate mean in each of the frames relative to the reference centroid coordinates is acquired.

In step S620, abnormal frames in which the corresponding deviation values do not conform to a predetermined deviation value are screened out from the plurality of frames.

In step S630, motion information at the plurality of time points within the abnormal frames is removed from the motion information at each of the time points, to obtain the processed motion information.

In specific implementation, when the motion information is screened from a dimension of a frame, the respective time points of the scanned object during the scan may be classified into a plurality of frames, coordinate means of MCCOD coordinates at each of the time points in the frames are calculated, and then distances between the coordinate means for the frames and the reference centroid coordinates are calculated, to obtain deviation values. Abnormal frames requiring removal of motion information are screened out according to the deviation values, and motion information at time points included in the plurality of time points in the abnormal frames is then removed from the motion information at each of the time points, to obtain the processed motion information.

More specifically, a specific manner of screening out the abnormal frames according to the deviation values may be taking frames in which the deviation values are greater than a predetermined deviation threshold (e.g., 5 mm) as the abnormal frames, or by sorting the deviation values at the respective frames in descending order, taking the frames in which the deviation values rank in the top N (N is an integer) or reach a certain proportion as the abnormal frames. Correspondingly, a predetermined condition for screening out the abnormal frames according to the deviation values may be that the deviation values are less than a deviation threshold or the deviation values do not rank in the top N or reach a certain proportion. That is, the frames that fail to meet the predetermined condition are screened out as the abnormal frames.

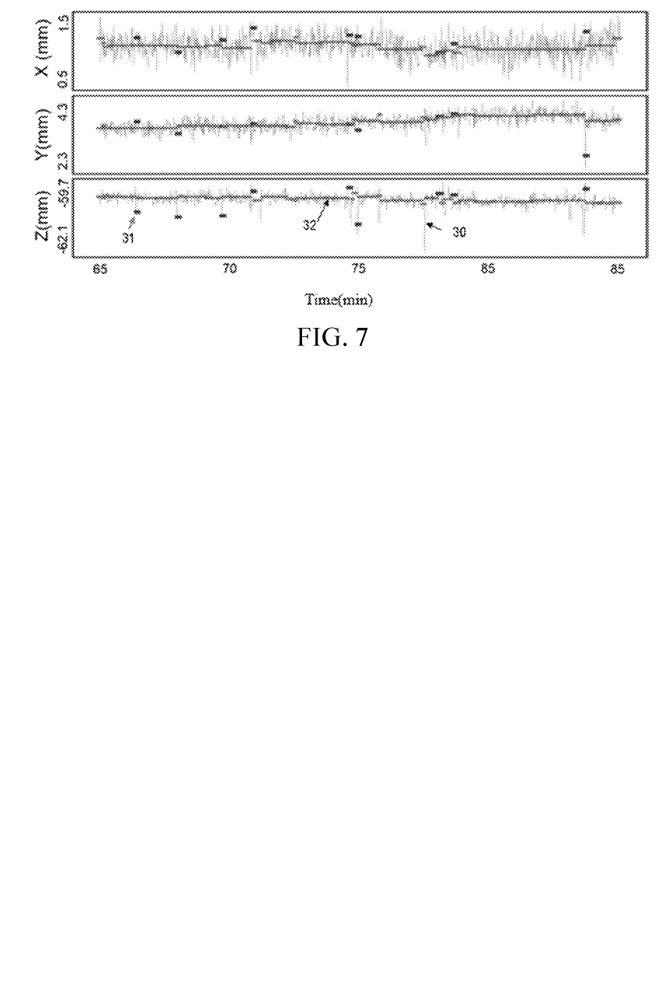

Refer to FIG. 7 which is a schematic diagram of an MCCOD curve after motion information screening processing in some embodiments. The MCCOD curve represents a variation curve of MCCOD coordinates of the scanned object over time. In the FIG. 7, a wavy curve 30 represents an original curve formed by the MCCOD coordinates of the scanned object at respective time points, individual segments 31 represent identified abnormal frames, and longer line segments 32 represent retained frames.

In this embodiment, screening processing is performed on the motion information from a dimension of a frame, which can simplify a data processing process and improve efficiency of processing on the motion information at each of the time points. By acquiring the deviation values of the coordinate means in each frame relative to the reference centroid coordinates, a relative offset of data points within each frame can be accurately measured, which facilitates the identification of the abnormal frames and mitigates an influence on data processing, thereby enhancing accuracy and stability of data processing.

When screening is performed from a dimension of a time point, correspondingly, in an exemplary embodiment, step S530 of performing the screening processing on the motion information at each of the time points based on the corrected performance indicators, to obtain the processed motion information further includes: acquiring deviation values of the MCCOD coordinates at each of the time points relative to the reference centroid coordinates; and based on a predetermined percentage, removing motion information for which the deviation values do not conform to a predetermined deviation value, from the motion information at each of the time points, to obtain the processed motion information.

In specific implementation, when the motion information is screened from a dimension of a time point, the deviation values of the MCCOD coordinates at each time point relative to the reference centroid coordinates can be directly acquired. That is, a distance between the MCCOD coordinates at each time point and the reference centroid coordinates is calculated. For the deviation values at each time point, whether the deviation values meet the condition is determined based on the predetermined deviation values. On a condition that the deviation values meet the condition, the motion information at the time point is retained. On a condition that the deviation values do not meet the condition, the motion information at the time point is removed. The motion information at the time points that conforms to the predetermined deviation values is integrated to obtain the processed motion information.

The predetermined deviation values are the same as predetermined deviation values for screening the motion information from a dimension of a frame, which may be that deviation values are less than a deviation threshold or the deviation values do not rank in the top N or reach a certain proportion. Specifically, when the deviation values corresponding to one time point is greater than the predetermined deviation threshold, it is determined that the deviation values at the time point does not meet the condition. Alternatively, the deviation values at each of the time points are sorted in descending order, and the time points at which the deviation values rank in the top N or reach a top predetermined percentage are determined as not meeting the condition.

In this embodiment, screening processing on the motion information from a dimension of a time point enables more refined screening of abnormal data, better retention of reliable data, and enhanced accuracy of the data processing process.

In an exemplary embodiment, the motion information at each of the time points is acquired in a first manner; and subsequent to step S530 of performing the screening processing on the motion information at each of the time points based on the corrected performance indicators, to obtain the processed motion information, the method further includes:

determining abnormal time points corresponding to removed motion information;

determining new motion information corresponding to the abnormal time points in a second manner, and replacing the motion information corresponding to the abnormal time points with the new motion information, to obtain adjusted motion information of the scanned object; and

obtaining the nuclear medicine image of the scanned object based on the adjusted motion information, the processed motion information, and the scanned raw data.

The second manner is different from the first manner. Both the first manner and the second manner may involve acquiring the motion information through an external device of the nuclear medicine imaging device (such as a structured-light camera) or obtaining the motion information by calculation according to raw data of a nuclear medicine scan, or the like. Acquiring the motion information through the external device such as the structured-light camera is generally faster and more accurate. However, the acquisition may fail in a few scenarios, for example, when a facial expression of the patient changes excessively, or when motion amplitude of the patient is excessively small. In such cases, the structured-light camera may fail to capture the motion information. In contrast, acquiring the motion information by using the raw data of the nuclear medicine scan (e.g., PET raw data) is unaffected by facial expressions, the camera's field of view, or ambient light changes, which generally may not fail, but requires substantial computational resources.

It may be understood that in step S130 of performing data collation processing, for example, screening processing, on the motion information at each of the time points, abnormal time points are required to be determined. After the abnormal time points are determined, the motion information at the abnormal time points may be removed from the motion information at each of the time points, to obtain the processed motion information, and the nuclear medicine image of the scanned object is obtained based on the processed motion information and the scanned raw data.

In another implementation, after the abnormal time points are determined, quality control may be further performed on the motion information at the abnormal time points, new motion information corresponding to the abnormal time points is determined in the second manner different from the first manner of initially determining the motion information, and step S520 to step S530 are performed again to identify whether the new motion information at the abnormal time points remains abnormal. If yes, the motion information at the abnormal time points is removed, and the nuclear medicine image of the scanned object is obtained jointly based on the processed motion information and the scanned raw data. If not, the new motion information at the abnormal time points is retained, and the nuclear medicine image of the scanned object is obtained jointly according to the new motion information corresponding to the abnormal time points, the processed motion information, and the scanned raw data.

More specifically, after the abnormal time points are determined, the new motion information corresponding to the abnormal time points is determined in the second manner. For example, in step S110, the motion information at each of the time points may be obtained by using an external structured-light camera as the first manner. After the abnormal time points are determined through step S110 to step S130, the motion information at the abnormal time points may be determined again by acquiring the motion information through the scanned raw data as the second manner, which is denoted as new motion information. Then, the motion information corresponding to the abnormal time points is replaced with the new motion information, to obtain adjusted motion information of the scanned object. Steps S120 to S130 are performed again for motion information at time points in the adjusted motion information, to obtain new processed motion information. On a condition that the new processed motion information includes the new motion information corresponding to the abnormal time points, it indicates that the new motion information at the abnormal time points is not identified as abnormal and is not removed. Therefore, the new motion information at the abnormal time points may be retained and participate in the motion correction of the nuclear medicine image. That is, the nuclear medicine image of the scanned object is obtained jointly according to the new motion information at the abnormal time points, the processed motion information, and the scanned raw data.

It may be understood that when the motion information is screened from a dimension of a frame, in the step of determining the abnormal time points corresponding to the removed motion information, abnormal frames corresponding to the removed motion information are determined. Correspondingly, motion information in the abnormal frames is determined in the second manner, and secondary quality control is performed. The principle is the same as the principle for processing the abnormal time points. Details are not described herein again.

In this embodiment, by determining new motion information at the abnormal time points corresponding to the removed motion information in different manners and replacing original motion information at the abnormal time points with the new motion information, quality control is performed on the motion information at the abnormal time points to identify whether the motion information remains abnormal. If not, the nuclear medicine image of the scanned object is obtained jointly according to the new motion information at the abnormal time points, the processed motion information, and the scanned raw data, thereby improving a data volume and completeness of the motion information on the basis of ensuring reliability and accuracy of the motion information, which can prevent an influence on the motion correction effect due to insufficient motion information data.

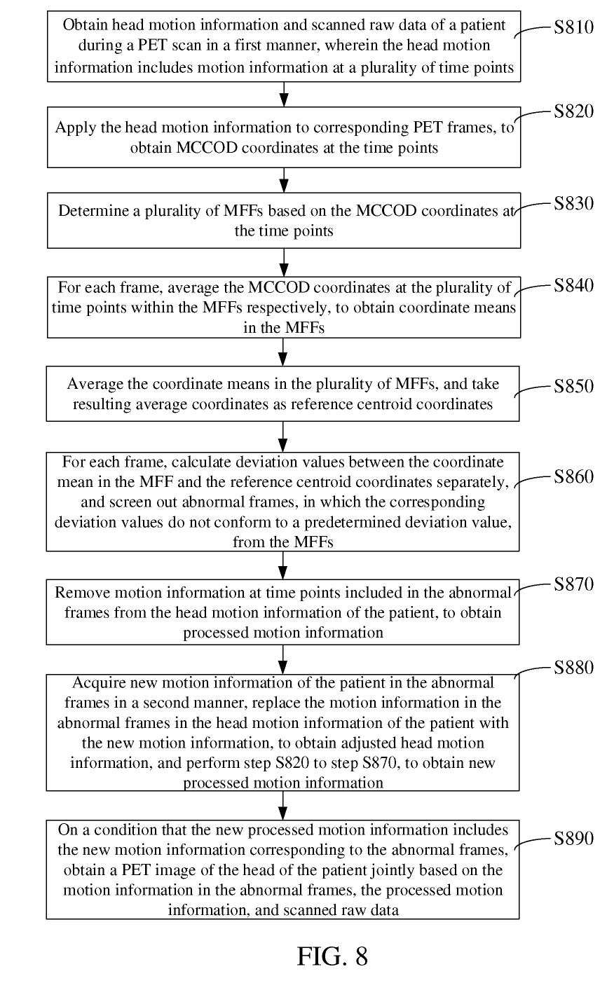

In some embodiments, to facilitate those skilled in the art to understand the embodiments of the present disclosure, the present disclosure is described below based on an example in which the head of the patient is the scanned object. Refer to FIG. 8 which is a schematic flowchart of a nuclear medicine image generation method illustrated based on an example in which the nuclear medicine image is a PET image, including steps S810 to S890.

In step S810, head motion information and scanned raw data of a patient during a PET scan are obtained in a first manner, the head motion information includes motion information at a plurality of time points.

In step S820, the head motion information is applied to corresponding PET frames, to obtain MCCOD coordinates at the time points.

In step S830, a plurality of MFFs are determined based on the MCCOD coordinates at the time points.

In step S840, for each frame, the MCCOD coordinates at the plurality of time points within the MFFs are averaged respectively, to obtain coordinate means in the MFFs.

In step S850, the coordinate means in the plurality of MFFs are averaged, and resulting average coordinates are taken as reference centroid coordinates.

In step S860, for each frame, deviation values between the coordinate mean in the MFF and the reference centroid coordinates is calculated separately, and abnormal frames in which the corresponding deviation values do not conform to a predetermined deviation value are screened out from the MFFs.

In step S870, motion information at time points included in the abnormal frames is removed from the head motion information of the patient, to obtain processed motion information.

In step S880, new motion information of the patient in the abnormal frames is acquired in a second manner, the motion information in the abnormal frames in the head motion information of the patient is replaced with the new motion information, to obtain adjusted head motion information, and step S820 to step S870 are performed, to obtain new processed motion information.

In step S890, on a condition that the new processed motion information includes the new motion information corresponding to the abnormal frames, a PET image of the head of the patient is obtained jointly based on the motion information in the abnormal frames, the processed motion information, and scanned raw data.

It is to be noted that, in an implementation, alternatively, the motion information may be screened by taking a signal other than the COD as a quality control tool for the motion information. For example, the motion information is screened by using a count rate curve. A count rate is a number of γ photons from positron annihilation that are detected by detectors. The count rate curve is a curve of count rate versus time, reflecting intensity of radiation in an object under test. A nuclear medicine reconstruction range may be determined according to changes in the count rate, and the count rate curve is updated in real time with scanned raw data.

In this embodiment, the acquired motion information during the scan is applied to the COD based on nuclear medicine acquisition data, thereby obtaining MCCOD. Abnormal or erroneous motion information may lead to discontinuous time segments where the MCCOD exhibits significant deviations, jumps, or the like. By identifying these time segments with a specific signal processing method and performing processing by discarding or recalculation, a head motion correction (HMC) result with a better effect can ultimately be achieved.

It should be understood that, although the steps in the flowchart as referred to in the embodiments as described above are shown in sequence as indicated by the arrows, the steps are not necessarily performed in the order indicated by the arrows. Unless otherwise clearly specified herein, the steps are performed without any strict sequence limitation, and the steps may be performed in other orders. In addition, at least some steps in the flowchart as referred to in the embodiments as described above may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately.

Based on a same invention concept, the embodiments of the present disclosure further provide a nuclear medicine image generation apparatus configured to implement the nuclear medicine image generation method as referred to above. The implementation solution provided by the apparatus to the problem is similar to the implementation solution described in the above method. Therefore, for specific limitations in one or more embodiments of a nuclear medicine image generation apparatus provided below, refer to the limitations on the nuclear medicine image generation method above. Details are not described herein again.

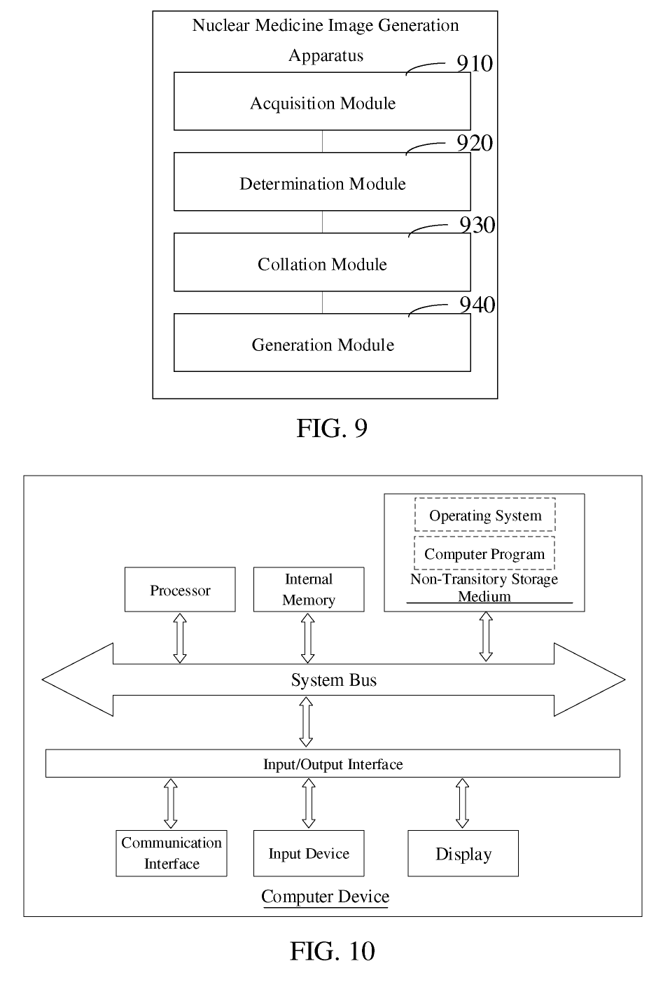

In some embodiments, as shown in FIG. 9, a nuclear medicine image generation apparatus is provided, including: an acquisition module 910, a determination module 920, a collation module 930, and a generation module 940.

The acquisition module 910 is configured to acquire motion information and scanned raw data of a scanned object at each of time points during a scan.

The determination module 920 is configured to determine three-dimensional coordinates of the scanned object at each of the time points based on the motion information at each of the time points.

The collation module 930 is configured to perform data collation processing on the motion information at each of the time points based on the three-dimensional coordinates at each of the time points, to obtain processed motion information.

The generation module 940 is configured to obtain a nuclear medicine image of the scanned object based on the processed motion information and the scanned raw data.

In some embodiments, the data collation processing includes merging processing; the processed motion information includes motion information in a plurality of sets; and the collation module 930 is further configured to perform the merging processing on the motion information at each of the time points based on the three-dimensional coordinates at each of the time points, to obtain the plurality of sets.

In some embodiments, the collation module 930 is further configured to classify the time points into the plurality of sets. A distance between three-dimensional coordinates of any two time points within each of the sets is less than a first threshold.

In some embodiments, the collation module 930 is further configured to determine an initial reference time point from the time points; acquire distances between three-dimensional coordinates at other time points in the time points and at the initial reference time point, and classify motion information at time points, at which the corresponding distances are less than a first threshold, in the other time points into a set corresponding to the initial reference time point; and select a new reference time point from the remaining time points, and perform re-merging processing based on distances between three-dimensional coordinates at other time points in the remaining time points except the new reference time point and at the new reference time point, until the three-dimensional coordinates at all the time points are traversed, to obtain the plurality of sets.

In some embodiments, the apparatus further includes a screening module, configured to filter the motion information in at least one of the sets, to obtain a plurality of target sets.

The generation module 940 is further configured to obtain the nuclear medicine image of the scanned object based on motion information in the target sets and the scanned raw data.

In some embodiments, the screening module is further configured to perform quality control on the motion information in at least one of the sets to obtain a quality control result, and group the motion information in at least one of the sets based on the quality control result to obtain the plurality of the target sets.t.

In some embodiments, the determination module 920 is further configured to determine a reference point of the scanned object; and determine three-dimensional coordinates of the reference point at each of the time points based on the motion information at each of the time points.

In some embodiments, the determination module 920 is further configured to acquire an initial spatial position of the reference point when the scan begins; and calculate the three-dimensional coordinates of the reference point at each of the time points based on the initial spatial position and the motion information at each of the time points.

In some embodiments, the determination module 920 is further configured to determine MCCOD coordinates of the scanned object at each of the time points based on the motion information and the scanned raw data at each of the time points; and acquire reference centroid coordinates. The data collation processing includes screening processing.

The collation module 930 is further configured to perform the screening processing on the motion information at each of the time points based on the corrected performance indicators, to obtain the processed motion information.

In some embodiments, the determination module 920 is further configured to classify the time points into a plurality of frames; for each frame, average the MCCOD coordinates at a plurality of time points within the frame, to obtain a coordinate mean in the frame; and average the coordinate means in the plurality of frames, and take resulting average coordinates as the reference centroid coordinates.

In some embodiments, the determination module 920 is further configured to determine a plurality of MFFs based on the motion information at each of the time points, a distance between three-dimensional coordinates at every two time points within each of the MFFs being less than a second threshold, and in two adjacent MFFs, a distance between three-dimensional coordinates at a last time point of a previous MFF and three-dimensional coordinates at a first time point of a subsequent MFF being greater than the second threshold; and take the plurality of MFFs as the plurality of frames obtained by classification.

In some embodiments, the collation module 930 is further configured to acquire deviation values of the coordinate means for the frames relative to the reference centroid coordinates; screen out, from the plurality of frames, abnormal frames in which the corresponding deviation values do not conform to a predetermined deviation value; and remove motion information at the plurality of time points within the abnormal frames from the motion information at each of the time points, to obtain the processed motion information.

In some embodiments, the collation module 930 is further configured to acquire deviation values of the MCCOD coordinates at each of the time points relative to the reference centroid coordinates; and based on a predetermined percentage, remove motion information for which the deviation values do not conform to a predetermined deviation value, from the motion information at each of the time points, to obtain the processed motion information.

In some embodiments, the motion information at each of the time points is acquired in a first manner. The apparatus further includes a secondary screening module configured to determine abnormal time points corresponding to the removed motion information; determine new motion information corresponding to the abnormal time points in a second manner, and replace the motion information corresponding to the abnormal time points with the new motion information, to obtain adjusted motion information of the scanned object; and obtain the nuclear medicine image of the scanned object based on the adjusted motion information, the processed motion information, and the scanned raw data.

The modules in the foregoing nuclear medicine image generation apparatus may be implemented entirely or partially by software, hardware, or a combination thereof. The above modules may be built in or independent of a processor of a computer device in a hardware form, or may be stored in a memory of the computer device in a software form, to facilitate the processor to invoke and perform operations corresponding to the above modules.

In some embodiments, a computer device is provided. The computer device may be a terminal. A diagram of an internal structure thereof may be shown in FIG. 10. The computer device includes a processor, a memory, a communication interface, a display screen, and an Input device connected through a system bus. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The communication interface of the computer device is configured to communicate with an external terminal in a wired or wireless manner. The wireless manner may be implemented through WIFI, a mobile cellular network, near field communication (NFC), or other technologies. The computer program is executed by the processor to implement a nuclear medicine image generation method. The display screen of the computer device may be a liquid crystal display screen or an electronic ink display screen. The Input device of the computer device may be a touchscreen covering the display screen, or may be a key, a trackball, or a touchpad disposed on a housing of the computer device, or may be an external keyboard, a touchpad, a mouse, or the like.

Those skilled in the art may understand that, in the structure shown in FIG. 10, only a block diagram of a partial structure related to the solution of the present disclosure is shown, which does not constitute a limitation on the computer device to which the solution of the present disclosure is applied. Specifically, the computer device may include more or fewer components than those shown in the FIG. 10, or some components may be combined, or a different component deployment may be used.

In some embodiments, a computer device is further provided, including a memory and a processor. The memory stores a computer program. The processor implements steps in the foregoing method embodiments when executing the computer program.

In some embodiments, a computer-readable storage medium is provided, having a computer program stored therein. When the computer program is executed by a processor, steps in the foregoing method embodiments are implemented.

In some embodiments, a computer program product is provided, including a computer program. When the computer program is executed by a processor, steps in the foregoing method embodiments are implemented.

It is to be noted that user information (including, but not limited to, device information of a user, and personal information of the user) and data (including, but not limited to, data for analysis, stored data, and displayed data) as referred to in the present disclosure are all information and data authorized by the user or fully authorized by all parties, and collection, use and processing of relevant data need to comply with the relevant laws, regulations, and standards of the relevant countries and regions.

Those of ordinary skill in the art may understand that some or all procedures in the methods in the foregoing embodiments may be implemented by a computer program instructing related hardware, the computer program may be stored in a non-transitory computer-readable storage medium, and when the computer program is executed, the procedures in the foregoing method embodiments may be implemented. Any reference to the memory, database, or other media used in the embodiments provided in the present disclosure may include at least one of a non-transitory memory and a volatile memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration but not a limitation, the RAM may be in a variety of forms, such as a static random access memory (SRAM) or a dynamic random access memory (DRAM). The database as referred to in the embodiments provided in the present disclosure may include at least one of a relational database and a non-relational database. The non-relational database may include a blockchain-based distributed database or the like, and is not limited thereto. The processor as referred to in the embodiments provided in the present disclosure may be a general-purpose processor, a central processing unit, a graphics processor, a digital signal processor, a programmable logic device, a quantum computing-based data processing logic device, or the like, and is not limited thereto.

Technical features in the foregoing embodiments may be randomly combined. To make the description concise, not all possible combinations of the technical features in the foregoing embodiments are described. However, the combinations of these technical features shall be considered as falling within the scope recorded by this specification provided that no conflict exists.

The foregoing embodiments merely express several implementations of the present disclosure. The description thereof is relatively specific and detailed, but cannot be understood as limitations on the patent scope of the present disclosure. It should be noted that for those of ordinary skill in the art, several transforms and improvements can be made without departing from the concept of the present disclosure, all of which fall within the protection scope of the present disclosure. Therefore, the protection scope of the present disclosure shall be subject to the appended claims.

What is claimed is:

1. A nuclear medicine image generation method, the method comprising:
acquiring motion information and scanned raw data of a scanned object at each of time points during a scan;
determining three-dimensional coordinates of the scanned object at each of the time points based on the motion information at each of the time points;
performing data collation processing on the motion information at each of the time points based on the three-dimensional coordinates at each of the time points, to obtain processed motion information; and
obtaining a nuclear medicine image of the scanned object based on the processed motion information and the scanned raw data.

2. The nuclear medicine image generation method according to claim 1, wherein the data collation processing comprises merging processing; the processed motion information comprises motion information in a plurality of sets; and performing the data collation processing on the motion information at each of the time points based on the three-dimensional coordinates at each of the time points, to obtain the processed motion information comprises:
performing the merging processing on the motion information at each of the time points based on the three-dimensional coordinates at each of the time points, to obtain the plurality of sets.

3. The nuclear medicine image generation method according to claim 2, wherein performing the merging processing on the motion information at each of the time points based on the three-dimensional coordinates at each of the time points, to obtain the plurality of sets comprises:
classifying the time points into the plurality of sets, wherein a distance between three-dimensional coordinates of any two time points within each of the sets is less than a first threshold.

4. The nuclear medicine image generation method according to claim 2, wherein after performing the merging processing on the motion information at each of the time points based on the three-dimensional coordinates at each of the time points, to obtain the plurality of sets, the method further comprises:
filtering the motion information in at least one of the sets, to obtain a plurality of target sets; and
obtaining the nuclear medicine image of the scanned object based on the processed motion information and the scanned raw data comprises:
obtaining the nuclear medicine image of the scanned object based on motion information in the target sets and the scanned raw data.

5. The nuclear medicine image generation method according to claim 4, wherein filtering the motion information in at least one of the sets, to obtain the plurality of target sets comprises:
performing quality control on the motion information in at least one of the sets to obtain a quality control result; and
grouping the motion information in at least one of the sets based on the quality control result to obtain the plurality of the target sets.

6. The nuclear medicine image generation method according to claim 1, wherein determining the three-dimensional coordinates of the scanned object at each of the time points based on the motion information at each of the time points comprises:
determining a reference point of the scanned object; and
determining three-dimensional coordinates of the reference point at each of the time points based on the motion information at each of the time points.

7. The nuclear medicine image generation method according to claim 6, wherein determining the three-dimensional coordinates of the reference point at each of the time points based on the motion information at each of the time points comprises:
acquiring an initial spatial position of the reference point when the scan begins; and
calculating the three-dimensional coordinates of the reference point at each of the time points based on the initial spatial position and the motion information at each of the time points.

8. The nuclear medicine image generation method according to claim 1, wherein after acquiring the motion information and the scanned raw data of the scanned object at each of time points during the scan, the method further comprises:
determining corrected performance indicators of the scanned object at each of the time points based on the motion information and the scanned raw data at each of the time points;
performing screening processing on the motion information at each of the time points based on the corrected performance indicators, to obtain processed motion information;
obtaining a nuclear medicine image of the scanned object based on the processed motion information and the scanned raw data.

9. The nuclear medicine image generation method according to claim 8, wherein performing screening processing on the motion information at each of the time points based on the corrected performance indicators, to obtain processed motion information, comprises:
determining abnormal indicators from the corrected performance indicators; and
performing the screening processing on the motion information based on the abnormal indicators, to obtain the processed motion information.

10. The nuclear medicine image generation method according to claim 9, wherein determining abnormal indicators from the corrected performance indicators, comprises:
acquiring reference indicators; and
determining the abnormal indicators based on deviation values between the corrected performance indicators and the reference indicators.

11. The nuclear medicine image generation method according to claim 10, wherein the corrected performance indicators comprise at least one of motion corrected centroid of distribution (MCCOD) coordinates, or corrected count rate curves.

12. The nuclear medicine image generation method according to claim 11, wherein acquiring the reference indicators comprises:
averaging the MCCOD coordinates at a plurality of time points, to obtain coordinate means as reference centroid coordinates.

13. The nuclear medicine image generation method according to claim 12, the method further comprises:
determining a plurality of motion free frames (MFFs) based on the motion information at each of the time points; wherein a distance between three-dimensional coordinates at every two time points within each of the MFFs is less than a second threshold, and in two adjacent MFFs, a distance between three-dimensional coordinates at a last time point of a previous MFF and three-dimensional coordinates at a first time point of a subsequent MFF is greater than the second threshold; and
taking the plurality of MFFs as a plurality of frames obtained by classification.

14. The nuclear medicine image generation method according to claim 13, wherein performing the screening processing on the motion information at each of the time points based on the corrected performance indicators, to obtain the processed motion information comprises:
acquiring deviation values of coordinate means for the frames relative to the reference centroid coordinates;
screening out, from the plurality of frames, abnormal frames in which the corresponding deviation values do not conform to a predetermined deviation value; and
removing motion information at the plurality of time points within the abnormal frames from the motion information at each of the time points, to obtain the processed motion information.

15. The nuclear medicine image generation method according to claim 12, wherein performing the screening processing on the motion information at each of the time points based on the corrected performance indicators, to obtain the processed motion information further comprises:
acquiring deviation values of the MCCOD coordinates at each of the time points relative to the reference centroid coordinates; and
removing, based on a predetermined percentage, motion information for which the deviation values do not conform to a predetermined deviation value, from the motion information at each of the time points, to obtain the processed motion information.

16. The nuclear medicine image generation method according to claim 15, wherein the motion information at each of the time points is acquired in a first manner; and after performing the screening processing on the motion information at each of the time points based on the corrected performance indicators, to obtain the processed motion information, the method further comprises:
determining abnormal time points corresponding to removed motion information;
determining new motion information corresponding to the abnormal time points in a second manner, and replacing the motion information corresponding to the abnormal time points with the new motion information, to obtain adjusted motion information of the scanned object; and
obtaining the nuclear medicine image of the scanned object based on the adjusted motion information, the processed motion information, and the scanned raw data.

17. A nuclear medicine image generation method, the method comprising:
acquiring motion information and scanned raw data of a scanned object at each of time points during a scan;
determining motion corrected centroid of distribution (MCCOD) coordinates of the scanned object at each of the time points based on the motion information and scanned raw data at each of the time points;
determining reference centroid coordinates based on the MCCOD coordinates at each of the time points;
performing screening processing on the motion information at each of the time points based on the reference centroid coordinates, to obtain processed motion information; and
obtaining a nuclear medicine image of the scanned object, based on the processed motion information and the scanned raw data.

18. A nuclear medicine image generation apparatus, the apparatus comprising:
an acquisition module configured to acquire motion information and scanned raw data of a scanned object at each of time points during a scan;
a determination module configured to determine three-dimensional coordinates of the scanned object at each of the time points based on the motion information at each of the time points;
a collation module configured to perform the data collation processing on the motion information at each of the time points based on the three-dimensional coordinates at each of the time points, to obtain processed motion information; and
a generation module configured to obtain a nuclear medicine image of the scanned object based on the processed motion information and the scanned raw data.

19. A computer device, comprising a memory and a processor, wherein the memory stores a computer program, and the processor, when executing the computer program, performs the nuclear medicine image generation method according to claim 1.

20. A non-transitory computer-readable storage medium, having a computer program stored therein, wherein the computer program, when executed by a processor, causes the processor to perform the nuclear medicine image generation method according to claim 1.
